(19) United States
(12) Patent Application Publication
(10) Pub. No.: US 2010/0253903 A1
(43) Pub. Date: Oct. 7, 2010

(54) Bridge for Clip-On Sunglasses and Auxiliary Lenses

(76) Inventor: Thomas E. Weston, Windham, ME (US)

Correspondence Address: Craig Dorais, 7 Cumberland Ave, Saco, ME, 04072, US

(21) Appl. No.: 12/701,406

(22) Filed: Mar. 5, 2010

Related U.S. Application Data
(60) Provisional application No. 61/150,314, filed on Feb. 5, 2009.

(51) Int. Cl. G02C 9/00

(52) U.S. Cl. 351/48; 351/58

(57) ABSTRACT

The instant invention introduces a clip-on eyewear assembly that is compatible with both framed and frameless clip-on eyewear and securely mounts to various sets of eyewear. This clip-on eyewear assembly features a centrally position bridge assembly, left and right lens members and attachment members that are used to hold the lens members in place when mounted to a set of eyewear. The bridge assembly typically provides some type of force to keep the lens members securely held to the set of eyewear to which the clip-on eyewear assembly is attached.

This application claims benefit of the filing date of patent application No. 61/150,314 filing date Feb. 5, 2009.

### FIELD OF THE INVENTION

The present invention relates generally to devices for securing at least one set of lenses over existing eyewear. More specifically the invention relates to clip-on attachment devices for securing a set of clip-on lenses over a set of eyewear.

### BACKGROUND OF INVENTION

Combining the properties of sets of lenses by stacking them on or near each other is old in the art of optics. Early scientific experiments were performed by passing light through one lens to another to observe the effects lenses had on light. Later, early telescopes and microscopes were devised to enhance human sight by combining multiple lenses. Also, magnification lenses were mounted about vision correcting eyewear to aid professionals such as jewelers. Over time it became popular for eyeglass wearers to mount light damping lenses over daily-wear eyeglasses to shield them from bright light, and one of the most popular means to mount such light dampening lenses are clip-on lenses.

Typically, clip-on lenses comprise a bridge and at least two lenses, wherein the lenses are mounted on opposing ends of the bridge. Further, it is very common for the lenses to comprise some type of securing means that allows the lenses to maintain a stable position over the lenses of eyewear the clip-on is mounted to.

This style of clip-on eyewear allows several advantages. First, it allows the wearer to keep only one set of vision correction glasses and still have protection from light without obtaining a second set of vision correcting and light dampening glasses. A user may simply put on and/or remove the clip-on eyewear over the vision correcting glasses as needed instead of switching between pairs of vision correcting glasses that do or do not dampen light. Another related benefit is that in the event that a wearer needs to replace their vision correction glasses (if they are lost, broken, out of date or out of style for instance) they may not need to replace their clip-on along with the glasses.

This last mentioned supposed benefit, however, is a bit more problematic in practice. Often, clip-on eyewear is not as ideally easy to mount on different styles of eyewear as one would reasonably suppose. This often forces glasses wearers to buy new clip-on eyewear whenever they change their glasses and even at times to settle for clip-on eyewear that doesn't mount comfortably to their glasses when a good matching clip-on cannot be found. Part of this problem stems from the common one-ridged-piece frame design found in clip-on eyewear, making the clip-on eyewear ridged to roughly mount to a relatively small range of eyewear for which it was intended.

Another drawback to the one-ridged-piece frame design includes the fact that such frames are too easily bent out of shape, forcing owners to bend the frames back into their proper shape before using again. This of course contributes to unnecessary wear on the frame itself thereby shortening the life of the frame.

Yet another drawback to the one-ridged-piece frame design is that frame users wish to protect their clip-on eyewear in some kind of carrying case need to carry an extra case of comparable dimensions to that of their actual glasses. To many, this seems an unnecessary redundancy and is certainly not ideally convenient.

What is needed is non-ridged designed clip-on eyewear that easily mounts to eyewear of virtually any type that is collapsible for convenient and safe carrying. The present invention provides a solution to these shortcomings in a simple, elegant and inexpensive design.

### SUMMARY OF THE INVENTION

The instant invention, as illustrated herein, is clearly not anticipated, rendered obvious, or even present in any of the prior art mechanisms, either alone or in any combination thereof. The instant invention relies upon a flexible and expandable bridge design for use with both frameless and framed clip-on eyewear. The instant invention includes various embodiments comprising various designs, materials, composites, components, sizes, and styles, wherein, at least one such embodiment of the instant invention is illustrated herein.

Therefore, it is an object of the present invention to overcome the previously mentioned shortcomings found in the prior art involving frameless and framed clip-on eyewear.

Another object of the present invention is to provide frameless or framed clip-on eyewear that easily mounts to other forms of eyewear.

Another object of the present invention is to provide clip-on eyewear that comprises a substantially flexible bridge apparatus.

Another object of the present invention is to create the appearance of a single line bridge that is more aesthetically pleasing and less intrusive to the glasses.

Another object of the present invention is to create a flexible bridge clip-on which consistently and substantially conforms to the eyewear to which it is applied.

Another object of the present invention is to provide clip-on eyewear that comprises a substantially flexible bridge apparatus, wherein said substantially flexible bridge apparatus comprises a substantially flexible and compressible bridge exoskeleton.

Another object of the present invention is to provide clip-on eyewear that comprises a substantially flexible bridge exoskeleton, wherein said substantially flexible bridge exoskeleton comprises a compression spring.

Another object of the present invention is to provide clip-on eyewear that comprises a substantially flexible bridge exoskeleton, wherein said substantially flexible bridge exoskeleton comprises a substantially flexible memory metal exoskeleton.

Another object of the present invention is to provide clip-on eyewear that comprises a substantially flexible bridge exoskeleton and at least one substantially flexible lens attaching member.

Another object of the present invention is to provide clip-on eyewear that comprises a substantially flexible bridge comprising at least one substantially flexible lens attaching member, wherein said at least one substantially flexible lens attaching member comprises a compression spring.

Another object of the present invention is to provide clip-on eyewear that comprises a substantially flexible bridge exoskeleton and at least one substantially flexible lens attaching member, wherein said at least one substantially flexible lens attaching member comprises memory metal.

Another object of the present invention is to provide clip-on eyewear that comprises a substantially flexible and compressible bridge, wherein said bridge comprises at least one substantially flexible lens attaching member, wherein said at least one substantially flexible lens attaching member comprises a compression spring exoskeleton, wherein in the ends of said compression exoskeleton spring attaches directly to left and right lens members.

Another object of the present invention is to provide clip-on eyewear that comprises a substantially flexible and compressible bridge exoskeleton comprising at least one substantially flexible lens attaching member, wherein said at least one substantially flexible lens attaching member comprises a monofilament line member.

Another object of the present invention is to provide clip-on eyewear that comprises a substantially flexible, compressible bridge exoskeleton and at least one substantially flexible lens attaching member, wherein said at least one substantially flexible lens attaching member comprises a braided cord member.

Another object of the present invention is to provide clip-on eyewear that comprises a substantially flexible and compressible bridge, wherein said bridge comprises at least one substantially flexible lens attaching member, wherein said at least one substantially flexible lens attaching member comprises a wire member.

Another object of the present invention is to provide clip-on eyewear that comprises a substantially flexible, compressible bridge exoskeleton and at least one substantially flexible lens attaching member, wherein said at least one substantially flexible lens attaching member comprises a torsion spring member.

Another object of the present invention is to provide clip-on eyewear that comprises a substantially ridged bridge exoskeleton and at least one substantially flexible lens attaching member, wherein said at least one substantially flexible lens attaching member comprises a memory metal member.

Another object of the present invention is to provide clip-on eyewear that comprises a substantially ridged bridge exoskeleton and at least one substantially flexible lens attaching member, wherein said at least one substantially flexible lens attaching member comprises a monofilament line member.

Another object of the present invention is to provide clip-on eyewear that comprises a substantially ridged bridge exoskeleton and at least one substantially flexible lens attaching member, wherein said at least one substantially flexible lens attaching member comprises a braided cord member.

Another object of the present invention is to provide clip-on eyewear that comprises a substantially ridged bridge exoskeleton and at least one substantially flexible lens attaching member, wherein said at least one substantially flexible lens attaching member comprises a substantially flexible wire member.

Another object of the present invention is to provide clip-on eyewear that comprises a substantially ridged bridge exoskeleton and at least one substantially flexible lens attaching member, wherein said at least one substantially flexible lens attaching member comprises a torsion spring member.

Another object of the present invention is to provide substantially rigid clip-on eyewear that comprises a substantially compressible exoskeleton and at least one substantially ridged lens attaching member.

Another object of the present invention is to provide clip-on eyewear that comprises a compression spring exoskeleton and two substantially ridged lens attaching member, wherein said two substantially ridged lens attaching member comprises a ridged metal (such as steel, stainless steel).

Another object of the present invention is to provide substantially flexible and substantially foldable clip-on eyewear that comprises a substantially ridged bridge exoskeleton and at least substantially flexible and stretchable elastic lens attaching members, wherein said elastic lens attaching members substantially overlap one another.

Another object of the present invention is to provide clip-on eyewear that comprises a substantially ridged bridge comprising a compressible exoskeleton and at least one substantially ridged lens attaching members, wherein said at least one substantially ridged lens attaching members comprises a ridged construction material (such as plastics and carbon fiber).

Another object of the present invention is to provide clip-on eyewear that comprises mounting members to mount said clip-on eyewear to other eyewear devices or assemblies.

Another object of the present invention is to provide clip-on eyewear that comprises mounting members, wherein said mounting members comprise hooks attached to lens members, wherein in said hooks substantially hold said clip-on eyewear to other eyewear devices, other eyewear assemblies or other eyewear members.

Another object of the present invention is to provide clip-on eyewear that comprises mounting members, wherein said mounting members comprise magnetic members attached to lens members, wherein in said magnetic members substantially hold said clip-on eyewear to other eyewear devices, other eyewear assemblies or other eyewear members.

Another object of the present invention is to provide clip-on eyewear that comprises mounting members, wherein said mounting members comprise clip-on holding apparatuses members attached to lens members, wherein in said clip-on holding apparatuses substantially hold said clip-on eyewear to other eyewear devices, other eyewear assemblies or other eyewear members.

Another object of the invention is to provide aligning pins substantially located in the top nasal quadrant of the clip-on lens, thereby providing positive alignment on the underlying eyewear.

Another object of the present invention is to provide clip-on eyewear that is easy to assemble.

Another object of the present invention is to provide clip-on eyewear that is readily foldable for easy carrying.

Another object of the present invention is to provide clip-on eyewear that is easy to assemble.

Another object of the present invention is that various embodiments of the instant invention are inexpensive to produce.

These together with other objects of the invention, along with various features of novelty which characterize the invention, are pointed out with particularity in the claims, Detailed Description of the Disclosed Embodiments sections and drawings of this application, with all said sections adding to this disclosure.

### BRIEF DESCRIPTION OF THE DRAWINGS

FIG. 1 illustrates a front view of one embodiment of the instant invention, wherein two lens members and a bridge assembly are visible.

FIG. 2 illustrates a front expanded view of the bridge assembly used in FIG. 1.

FIG. 3 illustrates a front expanded and exploded view of the bridge assembly used in FIGS. 1 and 2.

FIG. 4 illustrates a top down view of the bridge assembly used in FIG. 1, further revealing attachments means used to attach the bridge assembly to the lens members.

FIG. 5 illustrates a left mechanical foldable bridge connecting member.

FIG. 5a illustrates a right mechanical foldable bridge connecting member.

FIG. 6 illustrates a front view of an exoskeleton utilizing two bridge connecting members.

FIG. 7 illustrates a front view of a conventional pair of eyewear.

FIG. 8 illustrated a front view of the embodiment of the instant invention illustrated in FIG. 1 mounted to the conventional pair of eyewear in FIG. 7.

FIG. 9 illustrates a top view of the instant invention as illustrated in FIG. 1 mounted to the conventional pair of eyewear in FIG. 7 (FIG. 9 therefore is a top view of FIG. 8).

### DETAILED DESCRIPTION OF THE DISCLOSED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention, such as bridge assemblies and attachment members that have various sizes, dimensions and are comprised of various materials and configurations.

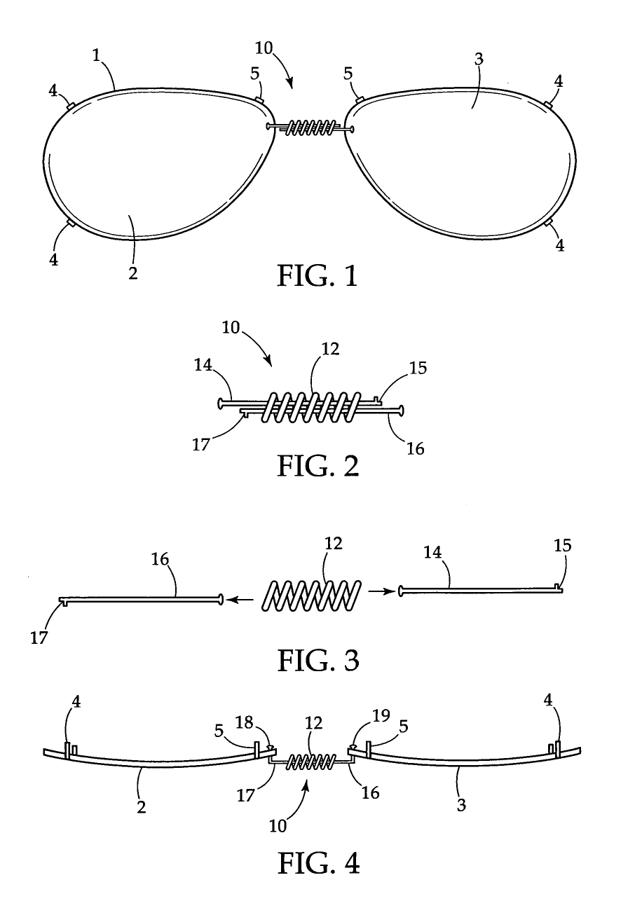

The present invention solves all the shortcomings found in the prior art by introducing a clip-on assembly 1 that substantially conforms to the dimension of the eyewear it mounts to. As illustrated in FIG. 1 this clip-on assembly 1 comprises at least one left lens member 2, at least one right lens member 3 and a bridge assembly 10. Further, in various embodiments of the instant invention at least one attachment member 4 (seen in FIG. 1 as a hook like attachment member) is permanently attached to said left and right lens members 2, 3 to allow the lens members to removably attach to the frame and/or lenses of the eyewear the clip-on mounts to. Additionally an aligning member 5 is substantially located about the top nasal quadrant of the left and right lens members 2, 3 allows for positive alignment of lens members 2, 3 with the underlying eyewear to which the clip-on assembly 1 attaches.

FIGS. 2 and 3 illustrate close up and exploded views of the bridge assembly 10 as illustrated in FIG. 1. In the embodiment of the instant invention illustrated in FIGS. 1 and 2 we see that the bridge assembly 10 comprises a substantially flexible and elastic exoskeleton 12 (seen in FIGS. 2 and 3 as a compression spring), a substantially flexible left attachment member 14 a left attachment member locking means 15, and a substantially flexible right attachment member 16 and left attachment member locking means 17. By observing the illustrations in FIGS. 2 and 3 we see that the left and right attachment members 14, 16 substantially pass through the substantially flexible and elastic exoskeleton 12 and wherein in FIG. 2 the left and right locking means 15, 17 make substantial contact with the ends of said substantially flexible and elastic exoskeleton 12. As such, when force is applied to the left and right attachment members 14, 16, pulling them in opposite directions to one another, the left and right locking means 15 and 17 upon making contact with the substantially flexible and elastic exoskeleton 12 cause the ends of the exoskeleton 12 to compress in on itself.

FIG. 4 illustrates a top view of the clip-on assembly 1 as illustrated in FIG. 1 and also illustrates left and right member attachment means 18, 19. These left and right member attachment means 18, 19 serve to secure the left and right attachment members 14, 16 to the left and right lens members 2, 3.

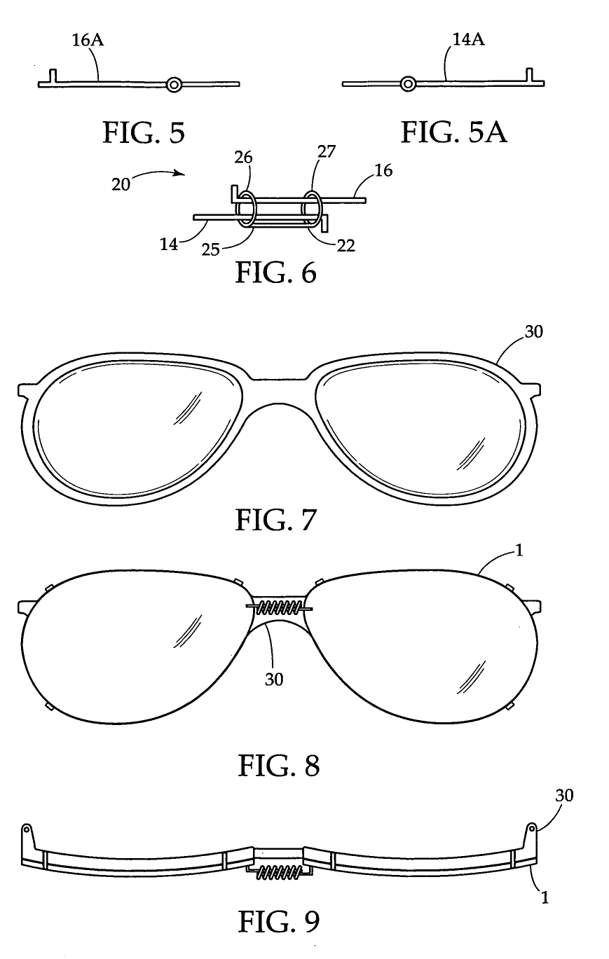

FIGS. 5 and 5a illustrate mechanically hinged attachment members 14A and 16A. These mechanically hinged attachment members 14A, 16A are used in embodiments of the instant invention as a substituted for the substantially flexible left and right attachment members 14, 16. In the embodiments utilizing the hinged attachment members 14A, 16A the ability to substantially conform about the frame of the underlying eyewear to which the clip-on assembly 1 is provided by the hinged feature and not the substantially flexible nature of the attachment members themselves.

FIG. 6 illustrates a substantially rigid bridge member 20 comprising a substantially ridged exoskeleton 25, wherein said exoskeleton comprises a substantially straight and substantially ridged frame member 22 and two substantially open passage members 26, 27. As illustrated in FIG. 6 the substantially ridged exoskeleton 25 comprises the two substantially open passage members 26, 27 as one substantially seamless and contiguous unit (i.e. substantially comprised of one member that is molded or shaped to provided the features described). Additionally illustrated in FIG. 6 are two substantially overlapping and substantially elastic lens connecting members 14, 16, that substantially pass through the two substantially open passage members 26, 27 while substantially parallel to one another. In this embodiment of the instant invention thereby providing substantially free movement to any lens members attached to them (such as the lens members 2, 3 as illustrated in FIG. 1.

FIGS. 7 and 8 are used to illustrate how the clip-on assembly 1 mounts onto a set of eyewear 30. In FIG. 6 we see a frontal view of a set of eyewear 30 before the clip-on assembly 1 is mounted to it. In FIGS. 7 and 8 we see front and top view, respectively, of the clip-on assembly 1 mounted to the set of eyewear 30.

FIG. 9 illustrates a top-down view of the clip-on assembly 1 mounted to a set of eyewear 30.

The process of mounting said clip-on assembly 1 to said set of eyewear 30 includes separating the left and right lenses of the clip-on assembly 1 (typically by gripping the left and right lens members 2, 3 apart) to an appropriate length so that the left and right lens members 2, 3 align properly with the respective lenses of the set of eyewear 30. After obtaining the proper length to align the left and right lens members 2, 3 with their respective lenses on the set of eyewear 30, the wearer uses the at least one attachment means 4 to hold the left and right lens members 2, 3 in place over their respective lenses from the set of eyewear 30. After securing the left and right lens members 2, 3 to their respective lenses from the set eyewear 30 by the at least one attachment means 4, the wearer may release the clip-on assembly 1. Note, upon releasing the clip-on assembly 1 the substantially flexible and elastic exoskeleton 12 will attempt to return to its normal rest state, thereby applying force pulling the left and right lens members 2, 3 towards each other, thereby keeping these lens members 2, 3 taught with the set of eyewear 30. The aligning pins 5 provide a means to substantially prevent the lens members 2, 3 from falling out of alignment with their corresponding lenses on the set of eyewear 30. The aligning pins 5 may be hooked or unhooked in nature, wherein the hooked version provides greater security and the unhooked versions provide greater freedom of movement and greater ease in mounting and demounting the clip-on assembly 1.

1. A bridge apparatus for clip-on sunglasses and auxiliary lenses comprising at least one bridge connector members, wherein every member of said at least one removeably attached bridge connector members comprises a spring engaging end, a clip-on auxiliary lens section attachment end and a compression spring member, wherein said at least one removeably attached bridge connector members are substantially disposed to pass through said compression spring member, wherein said spring engaging end of each member of said at least one removeably attached bridge connector members are positioned substantially opposite one another and, wherein each auxiliary lens section attachment end removeably attaches to said clip-on auxiliary lens section.

2. The bridge apparatus for clip-on sunglasses and auxiliary lenses of claim 1, wherein said at least one removeably attached bridge connector members further comprise non-mechanical flexible foldable bridge connector members.

3. The bridge apparatus for clip-on sunglasses and auxiliary lenses of claim 1, wherein said at least one removeably attached bridge connector members further comprise non-mechanical flexible foldable bridge connector members, wherein said non-mechanical flexible foldable bridge connector members are comprised from members of the group consisting of monofilament line, braided cord, wire cable, memory metal wire and torsion springs.

4. The bridge apparatus for clip-on sunglasses and auxiliary lenses of claim 3 further comprising at least one spring members, wherein said spring members comprise at least one member of a group consisting of memory metal, torsion spring and compression spring and, wherein at least one member of said at least one removeably attached bridge connector members comprises at least one member of a group consisting of memory metal, torsion spring and compression spring.

5. The bridge apparatus for clip-on sunglasses and auxiliary lenses of claim 3, wherein said at least one removeably attached bridge connector members are substantially rigid.

6. The bridge apparatus for clip-on sunglasses and auxiliary lenses of claim 5, wherein said at least one removeably attached bridge connector members comprise at least one member selected from the group consisting of metals, plastics, and composite materials.

7. The bridge apparatus for clip-on sunglasses and auxiliary lenses of claim 3 further comprising:
a top left lens nasal quadrant of a clip-on auxiliary lens section;
a top right lens nasal quadrant of a clip-on auxiliary lens section;
a plurality of aligning pins, wherein said plurality of aligning pins attach to said top left lens nasal quadrant and said top right lens nasal quadrant and, wherein said aligning pins substantial rest on the outer top edge of at least one lens of an eyewear apparatus.

8. The bridge apparatus for clip-on sunglasses and auxiliary lenses of claim 5, wherein said bridge connector members further comprises a lens section end and a hinge member attached to said lens section end.

9. The bridge apparatus for clip-on sunglasses and auxiliary lenses of claim 6, wherein said bridge connector member further comprises a lens section end and a hinge member attached to said lens section end.

10. The bridge apparatus for clip-on sunglasses and auxiliary lenses of claim 3, further comprising elastic bridge connector members.

11. The bridge apparatus for clip-on sunglasses and auxiliary lenses of claim 1 further comprising a flexible, foldable compression spring exoskeleton.

12. The bridge apparatus for clip-on sunglasses and auxiliary lenses of claim 10 further comprising a non-compressible exoskeleton.

13. The bridge apparatus for clip-on sunglasses and auxiliary lenses of claim 12, further comprising elastic bridge connector members.

14. A bridge apparatus for clip-on sunglasses and auxiliary lenses comprising a least one bridge connector members, wherein every member of said at least one removeably attached bridge connector members comprises a spring engaging end, a clip-on auxiliary lens section attachment end and at least one compression spring member, wherein said at least one removeably attached members are substantially disposed to pass through said compression spring member engaging said removeably attached bridge connector member, wherein each auxiliary lens section attachment end removeably attaches to said clip-on auxiliary lens section.

15. A bridge apparatus for clip-on sunglasses and auxiliary lenses comprising at least one aligning pin members attached to the top nasal quadrant of a left and right eye lens sections of clip-on auxiliary lenses at wherein each member of said at least one aligning pins substantially rests on a top outer edge of an eyewear apparatus.
